(19) United States
(12) Patent Application Publication
(10) Pub. No.: US 2026/0025345 A1
(43) Pub. Date: Jan. 22, 2026

(54) ASYNCHRONOUS MESSAGING FOR DELAY AND DISRUPTION TOLERANT NETWORKS

(71) Applicant: SPATIAM CORPORATION, Allen, TX (US)

(72) Inventor: Alberto Montilla Ochoa, Allen, TX (US)

(21) Appl. No.: 19/264,444

(22) Filed: Jul. 9, 2025

Related U.S. Application Data
(60) Provisional application No. 63/672,941, filed on Jul. 18, 2024.

(51) Int. Cl. H04L 51/046; H04L 51/18

(52) U.S. Cl. CPC H04L 51/046; H04L 51/18

(57) ABSTRACT

A computer-implemented method for transferring an asynchronous message over a Delay and Disruption Tolerant Network (DTN), through an asynchronous messaging system, includes receiving, by an interface service, a message from an application. The computer-implemented method further includes retrieving, by the interface service, an Endpoint Identifier (EID) from the received message. The EID identifies a destination node or a destination service to which the message is to be transferred over the DTN. Furthermore, the computer-implemented method includes identifying, by the interface service, a distinct instance of an intermediary service, corresponding to the EID. Furthermore, the computer-implemented method includes transferring, by the identified distinct instance of the intermediary service, the message to a core service, in form of a bundle protocol primitive compatible with the core service. The computer-implemented method further includes converting, by the core service, the bundle protocol primitive into an information bundle for transmission over the DTN.

### TECHNICAL FIELD

The present disclosure relates generally to the field of communication networks. More specifically, the present disclosure relates to asynchronous messaging for Delay and Disruption Tolerant Networks (DTNs).

### BACKGROUND

Delay and Disruption Tolerant Networking (DTN) is a specialized networking paradigm designed to facilitate communication in environments that suffer from intermittent connectivity, long delays, and disruptions. Traditional computer networks rely on continuous end-to-end connectivity between nodes, assuming that data can be transferred reliably and instantaneously. However, in many real-world scenarios, such as remote areas, disaster zones, space missions, or underwater exploration, maintaining such continuous connectivity is often impractical or impossible due to factors like limited infrastructure, mobility, or extreme environmental conditions. DTN addresses these challenges by employing a store-and-forward approach to data transmission. In the DTN, data is not required to be delivered directly from the source to the destination in a single hop. Instead, data is relayed through a series of intermediate nodes until it reaches its final destination. This enables communication even when direct end-to-end connectivity is unavailable or sporadic. The nodes in the DTN store incoming data locally and forward it opportunistically to other nodes when communication links become available.

To handle large-scale network management in Delay and Disruption Tolerant Networks (DTN), commanding and response (also known as control and reports) communication must be effectively managed in environments where traditional network connectivity is unreliable or intermittent. Asynchronous communications are essential in DTN scenarios where nodes may not always be in direct communication with one another due to factors such as distance, mobility, or infrastructure limitations. Existing solutions predominantly rely on accessing an operating console, typically through a Secure Shell (SSH), to execute commands within DTN. This approach necessitates sending commands while nodes are in contact with each other, limiting the effectiveness in scenarios where continuous connectivity cannot be guaranteed. Additionally, this method often operates at a lower level, using direct links, which inherently constrain the scalability of the system.

The reliance on SSH-based access to the operating console underscores the current reliance on manual intervention and real-time connectivity, both of which may not always be feasible or practical in DTN scenarios. In environments where nodes may be intermittently connected or have limited access to centralized management systems, the inability to perform commands asynchronously poses significant operational challenges. Moreover, the limitations, such as direct links, further worsen the scalability issues inherent in managing DTNs. The direct links typically involve establishing connections between individual nodes, which may not be feasible in large-scale deployments or environments with dynamic node configurations. As a result, the scalability of the existing solutions is inherently constrained, limiting their applicability in scenarios where expansive network coverage is required.

Consequently, there is a pressing need to address the aforementioned limitations with the development of management systems tailored to DTNs while leveraging asynchronous communications and operating effectively in low-connectivity environments. Such systems should be designed to accommodate the intermittent nature of DTN communications, allowing for the execution of commands and management tasks independent of real-time connectivity.

### SUMMARY

According to an aspect of the present disclosure, there is provided a computer-implemented method for transferring an asynchronous message over a Delay and Disruption Tolerant Network (DTN), through an asynchronous messaging system configured to run at least an interface service, one or more distinct instances of an intermediary service, and a core service. The computer-implemented method includes receiving, by the interface service, a message from an application. Furthermore, the computer-implemented method includes retrieving, by the interface service, an Endpoint Identifier (EID) from the received message. The EID identifies a destination node or a destination service to which the message is to be transferred over the DTN. Furthermore, the computer-implemented method includes identifying, by the interface service, a distinct instance of the intermediary service, corresponding to the EID. The computer-implemented method further includes transferring, by the identified distinct instance of the intermediary service, the message to the core service, in the form of a bundle protocol primitive compatible with the core service. The computer-implemented method further includes converting, by the core service, the bundle protocol primitive into an information bundle. The computer-implemented method also includes transferring, by the core service, the information bundle over the DTN to the destination node or the destination service. The interface service, the one or more distinct instances of the intermediary service, and the core service are configured to operate in accordance with Bundle Protocol (BP).

According to another aspect of the present disclosure, there is provided a computer-implemented method for receiving an asynchronous message over a Delay and Disruption Tolerant Network (DTN), through an asynchronous messaging system configured to run at least an interface service, one or more distinct instances of an intermediary service, and a core service. The computer-implemented method includes receiving, by the core service, an information bundle over the DTN. Furthermore, the computer-implemented method includes retrieving, by the core service, an Endpoint Identifier (EID) from the information bundle, and converting, by the core service, the information bundle into a bundle protocol primitive compatible with the core service. The EID identifies a destination node or a destination service to which the message needs to be delivered. Furthermore, the computer-implemented method includes identifying, by the core service, a distinct instance of the intermediary service, corresponding to the EID. The computer-implemented method further includes transferring, by the core service, the bundle protocol primitive to the identified distinct instance of the intermediary service. The computer-implemented method further includes extracting, by the identified distinct instance of the intermediary service, a message from the bundle protocol primitive. The computer-implemented method also includes transferring, by the interface service, the extracted message to the destination node or the destination service identified by the EID. Furthermore, the interface service, the one or more distinct instances of the intermediary service, and the core service are configured to operate in accordance with Bundle Protocol (BP).

According to another aspect of the present disclosure, there is provided an asynchronous messaging system for transferring an asynchronous message over a Delay and Disruption Tolerant Network (DTN). The asynchronous messaging system includes a memory unit including machine-readable instructions and a processor operably connected to the memory unit. The processor is configured to execute the machine-readable instructions, that when executed by the processor, enable the asynchronous messaging system to run at least an interface service, one or more distinct instances of an intermediary service, and a core service. The interface service is configured to receiving a message from an application, retrieve an Endpoint Identifier (EID) from the received message, wherein the EID identifies a destination node or a destination service to which the message is to be transferred over the DTN, and identify a distinct instance of the intermediary service, corresponding to the EID. Furthermore, the identified distinct instance of the intermediary service is configured to transfer the message to the core service, in form of a bundle protocol primitive compatible with the core service. Also, the core service is configured to convert the bundle protocol primitive into an information bundle, and transfer the information bundle over the DTN to the destination node or the destination service. Furthermore, the interface service, the one or more distinct instances of the intermediary service, and the core service are configured to operate in accordance with Bundle Protocol (BP).

According to another aspect of the present disclosure, there is provided an asynchronous messaging system for receiving an asynchronous message over a Delay and Disruption Tolerant Network (DTN). The asynchronous messaging system includes a memory unit including machine-readable instructions, a processor operably connected to the memory unit, the processor configured to execute the machine-readable instructions, that when executed by the processor, enable the asynchronous messaging system to run at least an interface service, one or more distinct instances of an intermediary service, and a core service. The core service is configured to receive an information bundle over the DTN, retrieve an Endpoint Identifier (EID) from the information bundle, and convert the information bundle into a bundle protocol primitive compatible with the core service, wherein the EID identifies a destination node or a destination service to which the message needs to be delivered, identify a distinct instance of the intermediary service, corresponding to the EID, and transfer the bundle protocol primitive to the identified distinct instance of the intermediary service. Furthermore, the identified distinct instance of the intermediary service is configured to extract a message from the bundle protocol primitive. Also, the interface service is configured to transfer the extracted message to the destination node or the destination service identified by the EID. Furthermore, the interface service, the one or more distinct instances of the intermediary service, and the core service are configured to operate in accordance with Bundle Protocol (BP).

### BRIEF DESCRIPTION OF THE FIGURES

For a more complete understanding of example embodiments of the present technology, reference is now made to the following descriptions taken in connection with the accompanying drawings in which:

FIG. 1 illustrates an example environment of devices and applications in which several embodiments of the present disclosure may be implemented;

FIG. 2 illustrates a logical block diagram of an asynchronous messaging system, in accordance with an embodiment of the present disclosure;

FIG. 3 is a block diagram illustrating a message communication workflow through an asynchronous messaging system and a Delay and Disruption Tolerant Network (DTN), in accordance with an embodiment of the present disclosure;

FIG. 4 illustrates a schematic representing various types of messages communicated between a user (through an application) and the asynchronous messaging system, in accordance with an embodiment of the present disclosure;

FIG. 5 illustrates a schematic representing communication between the application and an interface service, in accordance with an embodiment of the present disclosure;

FIG. 6 illustrates a schematic representing a process for transferring a message from the application to the DTN, in accordance with an embodiment of the present disclosure;

FIG. 7 illustrates a schematic representing a process for transferring a message from the DTN to the application, in accordance with embodiments of the present disclosure;

FIGS. 8A-8B illustrate schematics representing an end-to-end process for transferring a message between applications through the DTN via the asynchronous messaging system when two applications transfer messages to the DTN, in accordance with embodiments of the present disclosure;

FIG. 9 illustrates a computer-implemented method for transferring an asynchronous message over the DTN, through the asynchronous messaging system, in accordance with an embodiment of the present disclosure; and

FIG. 10 illustrates a computer-implemented method for receiving an asynchronous message over the DTN, through the asynchronous messaging system, in accordance with an embodiment of the present disclosure.

The drawings referred to in this description are not to be understood as being drawn to scale except if specifically noted, and such drawings are only exemplary in nature. Like reference numerals in the drawings denote like elements.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the context of the specification, the phrase “Bundle Protocol” or the term “BP” refers to a communication protocol designed for Delay and Disruption Tolerant Networks (DTNs), that operates as an overlay layer to bridge heterogeneous networks facing high latency and frequent, lengthy disruptions. BP encapsulates data into self-contained, persistent blocks called bundles, each with a unique Endpoint Identifier (EID) for routing and a defined lifetime to prevent indefinite network congestion. Unlike TCP/IP, which requires a contemporaneous end-to-end path, BP utilizes a Store, Carry, and Forward mechanism, where intermediate nodes store bundles in persistent memory until a forward-transmission opportunity arises. To ensure reliability across these unstable links, BP employs a hop-by-hop custody transfer system, where a node retains a copy of a bundle until the next node formally accepts responsibility for the bundle, thus tolerating intermittent connectivity without data loss.

In the context of the specification, the term “application” refers to software programs specifically designed to function over the Bundle Protocol, embracing the asynchronous nature of the underlying network. Unlike traditional internet applications that assume a persistent, low-latency connection (like live streaming or Web Browsers), DTN applications are built to tolerate long delays and intermittent connectivity by sending and receiving data as self-contained bundles without expecting an immediate response. Examples include systems for asynchronous file transfer, messaging clients for deep space or disaster-response scenarios, and automated data collection tools for remote scientific sensors. These applications interface directly with the Bundle Protocol layer to dispatch bundles and are architected to operate intermittently, configured for data delivery that may take hours, days, or even longer.

In the context of the specification, the term “service” refers to a self-contained, autonomous program that performs a specific, well-defined function and makes its capabilities available to other software components, known as clients, over a network through a standardized interface like an API. A service operates independently, often running in the background, to handle a distinct business logic or technical task, such as authentication, processing of information, or providing data. This architectural pattern allows complex applications to be built from smaller, decoupled, and reusable pieces that can be developed, deployed, and scaled individually, forming the foundation for modern architectures like Service-Oriented Architecture (SOA) and microservices.

In the context of the specification, “distinct instances of a service” refer to individually configured and operating iterations of a service, each specifically designed to interact with a unique target. These instances are tailored to deliver messages or commands to either distinct physical or logical nodes within the network, or to distinct applications residing on those nodes. The tailoring involves specific configurations for each instance, such as destination addressing, message formatting, or command parameters, ensuring that the information received over the intermittent and potentially long-delay DTN is accurately and appropriately routed and interpreted by its intended, unique recipient.

Various embodiments of the present disclosure provide computer-implemented methods and an asynchronous messaging system (hereinafter also referred to as “the system”) for transferring and receiving asynchronous messages over Delay and Disruption Tolerant Networks (DTNs). The system includes multiple components, including an interface service, intermediary service instances, and a core service. The interface service acts as a bridge between applications and the DTN, enabling secure data transmission and asynchronous execution of commands. The core service is responsible for handling actual data transmission and reception within the bundle protocol framework, managing messages according to Bundle Protocol (BP) specifications, interfacing with various transport protocols, and implementing security measures.

The message communication workflow involves applications generating messages, which are then forwarded to the interface service. The interface service identifies a distinct instance of an intermediary service based on an Endpoint Identifier (EID) contained in the message. This intermediary service instance then transforms the message into a bundle protocol primitive compatible with the core service. The core service subsequently sends this information bundle over the DTN to the designated destination.

Conversely, for message reception, the core service at the receiving end receives an information bundle from the DTN, retrieves the EID, and converts it into a bundle protocol primitive. The bundle protocol primitive is then transferred to a distinct instance of the intermediary service, which unpacks the message. Finally, the interface service transfers the extracted message to the intended application. The entire process is designed to operate asynchronously, allowing for robust communication even in environments with intermittent connectivity and significant delays.

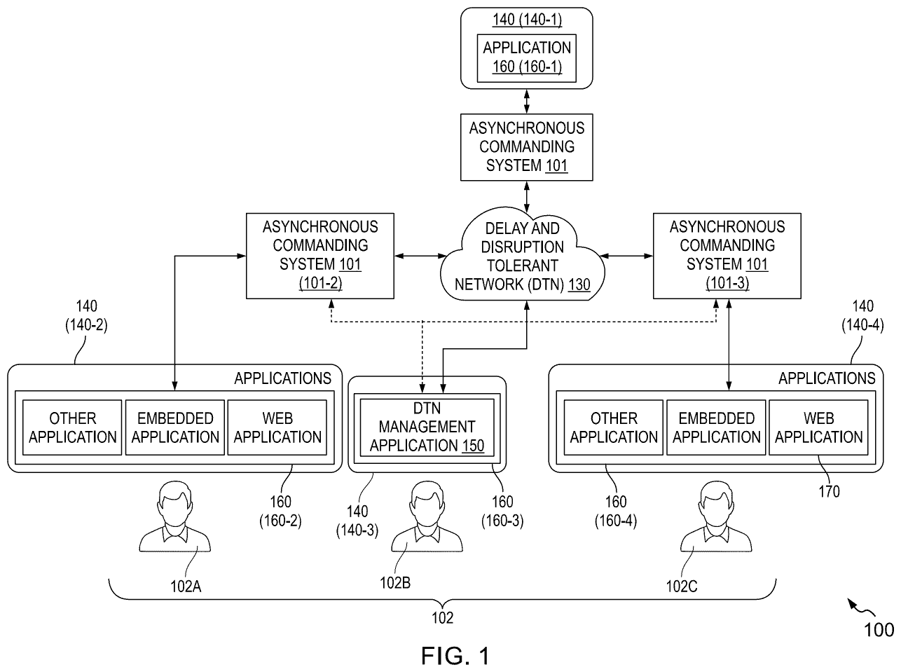

FIG. 1 illustrates an example environment 100 of devices and applications in which several embodiments of the present disclosure may be implemented. Although the environment 100 is presented in one arrangement, other embodiments may include the parts of the environment 100 (or other parts) arranged otherwise, depending on, for example, an asynchronous messaging system 101 (hereinafter also referred to as “the system 101”) for DTN 130. The present disclosure is intended to enable users to send and receive user and administrative data, obtain management reports, and oversee the remote management and configuration of managed DTN nodes. The asynchronous messaging system 101 allows users to securely transfer data through a Delay and Disruption Tolerant Networking (DTN) network. Additionally, the asynchronous messaging system 101 provides users with the ability to remotely access important features of DTN nodes. These features are utilized for both user application purposes and administrative tasks. In essence, the system 101 facilitates secure data transmission and remote management of DTN nodes to support various user needs and operational requirements.

The example representation of the environment 100 as depicted in FIG. 1 includes a plurality of entities, such as 102A, 102B, and 102C (collectively referred to as “the entities 102” and individually referred to as “the entity 102”). The entities 102 can include end users who transfer or receive messages through the multiple instances 101-1, 101-2, and 101-3 of the asynchronous messaging system 101 (collectively referred to as “the asynchronous messaging system 101” or “the system 101”) and DTN 130. The entities 102 may also include autonomous vehicles, remote sensors, terrestrial and sub-aquatic systems, Internet of Things (IoT) devices, and any other individuals, groups of individuals, organizations, autonomous devices, autonomous systems, groups of autonomous devices, or groups of autonomous systems capable of accessing the applications 160.

The DTN 130 defines a communications network or combination of communication networks that are configured for Delay and Disruption Tolerant Networking (DTN). The DTN 130 is configured for communications between communication devices 140 (for example, 140-1, 140-2, 140-3, and 140-4) (interchangeably referred to as “the electronic devices 140”) or between applications 160-1, 160-2, 160-3, and 160-4 (collectively referred to as “the applications 160” and individually referred to as “the application 160”) operated in the communication devices in a time-varying environment 100. The communication devices 150 may be operated by one or more users. In one embodiment, the users may correspond to end users of the applications 160 that are built for the user's convenience. In another embodiment, the users may be designers, developers, programmers, network operators, or the like who are involved in developing and operating such websites, applications, and networks.

The entities 102 can include an administrator who can control the communication with the DTN 130 through the asynchronous messaging system 101. The environment 100 also includes a front-end user interface (UI) of a web application or an application 160 displayed on the communication devices 140, allowing users to produce or receive messages through the application 160. The asynchronous messaging system 101 serves as an adapter between the applications 160 and the DTN 130, enabling the transfer of data and asynchronous execution of commands. In a non-limiting example, the entities 102 may use any type of the electronic devices 140, such as but not limited to, a desktop computer, a smartphone, a tablet computer, a mobile phone, a laptop computer, a personal digital assistant, a web-enabled wearable device, a smart television, and the like.

The applications 160 through which the entities 102 can produce or receive the messages may be of multiple types, such as but not limited to a web application 170, embedded into a communication device (for instance, the communication device 140-2 or the communication device 140-4), or other type of software applications, including the DTN management application 150. The DTN management application 150 can include a specific application that uses the asynchronous messaging system 101 for DTN node management. ADTN node, an element in the DTN 130, can include the element in charge of processing and forwarding bundles (unit of data in a bundle protocol) in the DTN 130. The applications 160 may be local or remote to the users, such as the application 160-1 is remote to the entities 102.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the system 101 should be understood to be embodied in at least one computing device in communication with the DTN 130, which may be specifically configured, via executable instructions, to perform steps as described herein, and/or embodied in at least one non-transitory computer-readable media.

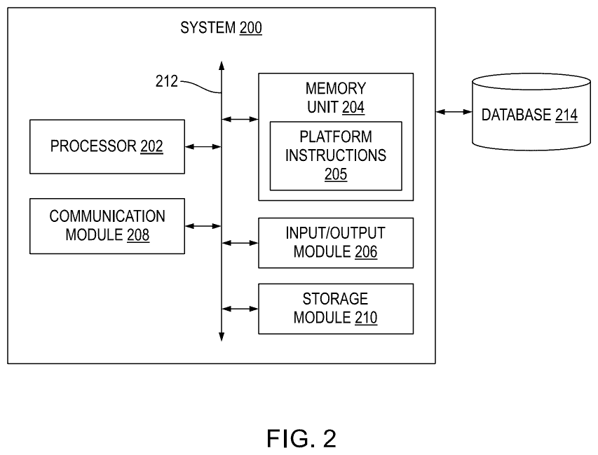

FIG. 2 illustrates a logical block diagram of an asynchronous messaging system 200 (hereinafter also referred to as “the system 200”), in accordance with an embodiment of the present disclosure. The system 200 is identical to the system 101 of FIG. 1. The system 200 is caused to enable communication between the applications 160 and the DTN 130. In some embodiments, the system 200 may be deployed within a digital platform server, or may be placed external to, and in operative communication with, the digital platform server. In other embodiments, the system 200 may be implemented as a digital platform server.

The system 200 is depicted to include multiple components such as a processor 202, a memory unit 204, an Input/Output (I/O) module 206, a communication module 208, and a storage module 210. The various components of the system 200, such as the processor 202, the memory unit 204, the I/O module 206, the communication module 208, and the storage module 210, are configured to communicate with each other via or through a centralized circuit system 212. The centralized circuit system 212 may include various devices configured to, among other things, provide or enable communication between the components of the system 200. In certain embodiments, the centralized circuit system 212 may be a central Printed Circuit Board (PCB) such as a motherboard, a main board, a system board, or a logic board. The centralized circuit system 212 may also include other Printed Circuit Assemblies (PCAs) or communication channel media.

In some embodiments, the system 200 is associated with a database 214. In another embodiment, the database 214 may be integrated within the storage module 210 as well. For example, the storage module 210 may include one or more hard disk drives as the database 214. The database 214 is configured to store messages and associated information such as time stamps, source ID, destination identifier, etc.

It is noted that although the system 200 is depicted to include the processor 202, the memory unit 204, the Input/Output (I/O) module 206, the communication module 208, and the storage module 210, in some embodiments, the system 200 may include more or fewer components than those depicted herein. The various components of the system 200 may be implemented using hardware, software, firmware, or any combination thereof.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may include connected logic units, such as gates and flip-flops, and may comprise programmable units, such as programmable gate arrays or processors. The modules described herein may be implemented as either software and/or hardware modules and may be stored in any type of computer-readable medium or other computer storage device.

In one embodiment, the processor 202 may be embodied as a multi-core processor, a single-core processor, or a combination of one or more multi-core processors and one or more single-core processors. For example, the processor 202 may be embodied as one or more of various processing devices, such as a coprocessor, a microprocessor, a controller, a general-purpose Central Processing Unit (CPU), a Graphics Processing Unit (GPU), a Digital Signal Processor (DSP), a processing circuitry with or without an accompanying DSP, or various other processing devices including integrated circuits such as, an Application Specific Integrated Circuit (ASIC), a Field Programmable Gate Array (FPGA), a Microcontroller Unit (MCU), a hardware accelerator, a special-purpose computer chip, or the like. In one embodiment, the memory unit 204 is capable of storing machine-readable instructions, referred to herein as platform instructions 205.

Further, the processor 202 is capable of executing the platform instructions 205. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the platform instructions 205 are executed. For example, in at least some embodiments, each component of the processor 202 may be configured to execute instructions stored in the memory unit 204 for realizing respective functionalities, as will be explained in further detail later.

The memory unit 204 may be embodied as one or more non-volatile memory devices, one or more volatile memory devices, and/or a combination of one or more volatile memory devices and non-volatile memory devices. For example, the memory unit 204 may be embodied as semiconductor memories, such as flash memory, mask Read Only Memory (ROM), programmable ROM (PROM), Erasable PROM (EPROM), Random Access Memory (RAM), Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, Pseudo-Static RAM (PSRAM), and the like.

In at least some embodiments, the memory unit 204 stores logic and/or instructions, which may be used by elements of the processor 202. For example, the memory unit 204 includes instructions that are executed by the processor 202 to perform one or more actions of the system 200.

In an embodiment, to enable the reception of inputs and provide outputs to the system 200, the I/O module 206 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a Light-Emitting-Diode (LED) display, a Thin-Film Transistor (TFT) display, a Liquid Crystal Display (LCD), an Active-Matrix Organic Light-Emitting Diode (AMOLED) display, a microphone, a speaker, a ringer, and the like.

In an example embodiment, at least one module of the system 200 may include an I/O circuitry (not shown in FIG. 1) configured to control at least some functions of one or more elements of the I/O module 206, such as, for example, a speaker, a microphone, a display, and/or the like. The processor 202 of the system 200 and/or the I/O circuitry may be configured to control one or more functions of the elements of the I/O module 206 through computer program instructions, for example, software and/or firmware, stored on a memory, for example, the memory unit 204, and/or the like, accessible to the processor 202 of the system 200.

The communication module 208 is configured to facilitate communication between various applications over the DTN 130. In some embodiments, the communication module 208 may be configured to facilitate the system 200 to establish communication with various applications, such as the applications 160 and the DTN 130.

The storage module 210 is any computer-operated hardware suitable for storing and/or retrieving data. In one embodiment, the storage module 210 is configured to store the content of messages, metadata associated with the messages communicated over the DTN 130, and the like. The storage module 210 may include multiple storage units, such as hard drives and/or solid-state drives in a Redundant Array of Inexpensive Disks (RAID) configuration. In some embodiments, the storage module 210 may include a Storage Area Network (SAN) and/or a Network Attached Storage (NAS) system. In one embodiment, the storage module 210 may correspond to a distributed storage system, wherein individual databases are configured to store custom information, such as event logs.

In some embodiments, the processor 202 may access the storage module 210 using a storage interface (not shown in FIG. 2). The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the storage module 210.

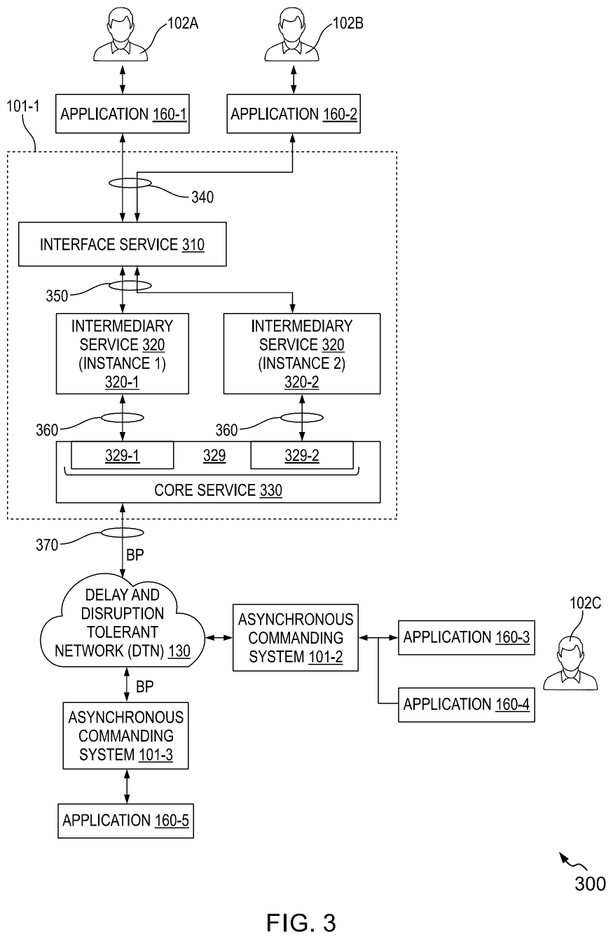

FIG. 3 is a block diagram illustrating a message communication workflow 300 through an asynchronous messaging system 101 and the DTN 130, in accordance with an embodiment of the present disclosure. Each instance of the multiple instances 101-1, 101-2, and 101-3 of the asynchronous messaging system 101 (collectively referred to as “the asynchronous messaging system 101”) facilitates the transfer of messages to the respective associated applications. The asynchronous messaging system 101 may utilize bundle protocols to transfer messages between the application 160 and the DTN 130. As illustrated in FIG. 3, the asynchronous messaging system 101 may include an interface service 310 to provide an application interface for applications 160-1 and 160-2 (collectively referred to as “the applications 160” and individually referred to as “the application 160”). The applications 160-1 and 160-2 can be connected to the interface service 310 through a communication interface 340. The communication interface 340 can include, but not limited to, sockets, data buses, web application programmable interfaces, etc.

The interface service 310 maintains a mapping or association between instances 320-1 and 320-2 of an intermediary service 320 and their corresponding applications 160. For example, interface service 310 maintains a mapping between the application 160-1 and a first distinct instance 320-1 of the intermediary service 320, and a mapping between the application 160-2 and a second distinct instance 320-2 of the intermediary service 320. The interface service 310 can also maintain which core service endpoint 329-1 or 329-2, of core service endpoints 329, is mapped to which instance 160-1 or 160-2, respectively, of the applications 160, ensuring that data intended for a specific application 160 is routed correctly. The core service endpoints 329 are part of a core service 330. The core service endpoints 329 maybe identified by core service endpoint identifiers as defined in bundle protocol version [RFC9171].

The interface service 310 may establish a connection between an application (for example, the application 160-1) of the applications 160 and the respective distinct instance 320-1 of the intermediary service 320. The interface service 310 acts as a bridge, facilitating communication by opening the necessary pathways for data transfer. Each application 160 and the respective distinct instance 320-1 or 320-2 of the intermediary application 320 connect to the interface service 310 using an individual application interface identifier (ID) defined by a user. The intermediary service 320 initiates a session or connection to start communicating using the bundle protocol.

It is to be noted here that a conventional service on a standard server typically listens on a network socket (like a TCP port), expecting to establish a live, end-to-end connection with a client. The entire operational logic of the conventional service revolves around receiving a request and providing a response within that stable, real-time session. If the connection breaks, the transaction fails. In contrast, a service running on the system 101, such as the interface service 310, the instances 320-1 and 320-2 of the intermediary service 320, and the core service 330, does not maintain live sessions with remote clients. The service running of the system 101 is designed to function correctly even if it is completely isolated for hours, days, or weeks, processing data only when a bundle finally arrives, making its core logic inherently a synchronous and resilient to the extreme network volatility that would instantly crash a traditional service. In that regard, the interface service 310, the instances 320-1 and 320-2 of the intermediary service 320, and the core service 330 are configured to operate in accordance with the Bundle Protocol.

Each distinct instance 320-1 and 320-2 of the intermediary service 320 is assigned a specific service number, which is a unique identifier defined in RFC9171. RFC9171 is a standard that specifies how the bundle protocol operates, including how service numbers are used. The service number is similar to a port number in traditional networking, directing the data to the correct distinct instance 320-1 or 320-2 of the intermediary service 320. The intermediary service 320 is configured to be recognized by the BP implementation during initialization, ensuring that the instances 320-1 and 320-2 of the intermediary service 320 can interact with the core service 330 at a service number, which is defined by the user. The BP instances 320-1 and 320-2 of the intermediary service 320 are built specifically for a unique configuration of the core service 330; therefore, a configuration of the intermediary service 320 is unique to a given configuration of the core service 330.

Once a distinct instance 320-1 or 320-2 of the intermediary service 320 is initialized, the distinct instance 320-1 or 320-2 performs a handshake with the interface service 310. The handshake can be performed through communication interfaces, including system sockets 350. The interface service 310 creates a relationship mapping between the distinct instance 320-1 or 320-2 of the intermediary service 320 and the respective application 160 based on their application interface IDs. This mapping can be stored both in process memory and in non-volatile memory for persistence and robustness. At this point, the interface service 310 can act as a message broker between the application 160 and the respective distinct instance 320-1 or 320-2 of the intermediary application 320.

Typically, the instances 320-1 and 320-2 of the intermediary service 320 are developed using the same low-level programming languages as the core service 330. This alignment in programming languages facilitates efficient communication and resource management between the instances 320-1 and 320-2 of the intermediary service 320 and the core service 330. However, if the core service 330 offers specific utilities or APIs for other languages, the instances 320-1 and 320-2 of the intermediary service 320 might be implemented using those other languages instead. The instances 320-1 and 320-2 of the intermediary service 320 act as forwarders and receivers of messages. Upon receiving the message from the interface service 310, the instances 320-1 and 320-2 of the intermediary service 320 can transform the message into a format that is specific to the core service 330. For example, the messages received from the associated application 160 through the interface service 310 are transformed into a byte-stream.

The instances 320-1 and 320-2 of the intermediary service 320 serve a crucial role in facilitating communication between the application 160 and the core service 330. The instances 320-1 and 320-2 of the intermediary service 320 can specifically map the communication interface 350 of the application 160 to the specific primitives or basic operations of the core service 330. The primitives vary depending on the particular implementation of the core service 330, ensuring that the application 160 can interact seamlessly with the underlying network protocol despite differences in implementation.

A key feature of the message communication workflow 300 is that the interface service 310 remains agnostic of the implementation of the core service 330. In other words, the interface service 310 does not need to be aware of the specific details of the core service 330 being used. Instead, the separate instances 320-1 and 320-2 of the intermediary service 320 for each supported core service 330 and application 160 handle the nuances of different implementations. This design supports various forwarding functions and requirements unique to each type of core service 330, ensuring flexibility and adaptability across different systems.

The core service 330 may be configured to handle actual data transmission and reception within the bundle protocol framework. The core service 330 uses distinct core service endpoints 329 to manage data from different applications 160. The core service 330 is a set of processes designed to implement the Bundle Protocol (BP), which is a fundamental component of Delay and Disruption Tolerant Networking. The core service 330 ensures reliable data communication in environments where connectivity can be intermittent and delays can be significant. Some of the functionalities of the core service 330 may include memory management, message reception and delivery, and security, all tailored to maintain the integrity and efficiency of data transfers.

The core service 330 can also handle message reception and delivery with precision. At the BP level, the core service 330 manages the reception and delivery of messages according to the BP specifications, ensuring that bundles are processed correctly and efficiently. At the convergence layer level, the core service 330 can interface with various transport protocols, including Transmission Control Protocol (TCP), Licklider Transmission Protocol (LTP), and User Datagram Protocol (UDP). These protocols can handle the lower-level transport-specific operations, facilitating reliable and efficient data transfer across different types of networks.

Security is another critical function of the core service 330. The core service 330 may be configured to implement comprehensive security measures to protect the integrity and confidentiality of bundles during transmission. The security measures include encryption to safeguard data privacy, authentication to verify the identity of nodes, and integrity checks to detect and prevent data corruption. By incorporating the security measures, the core service 330 ensures that data remains secure and trustworthy, even in potentially hostile environments.

Data handling within the core service 330 can be managed through a combination of process memory and persistent logs. For example, information such as runtime information and actively managed data is stored in process memory, allowing for quick access and manipulation. Persistent logs, on the other hand, ensure that critical information about bundle transactions is retained across system reboots or failures. This persistence is essential for data recovery and auditing, providing a reliable record of all transactions. Moreover, the core service 330 can manage the transportation of bytes between nodes, ensuring that data is accurately delivered to the intended applications. This capability is vital for maintaining seamless communication between different parts of the network.

Several examples of the core service 330 highlight the diversity of implementations that the instances 320-1 and 320-2 of the intermediary service 320 support. These include the NASA/JPL Interplanetary Overlay Network (ION) Implementation, the NASA DTN Marshall Enterprise (DTNME) implementation, the NASA High-Rate DTN (HDTN) implementation, the European Space Agency (ESA) Java Bundle Protocol implementation, and the D3TN μD3TN implementation. Each of these implementations has its own set of primitives and operational characteristics, which the endpoint connector must accommodate.

The instances 320-1 and 320-2 of the intermediary service 320 can be connected with the core service 330 through the communication interface 360 specific to the application 160. This means that there is a separate distinct instance 320-1 or 320-2 of the intermediary service 320 for each supported application 160 as shown in FIG. 3. The instances 320-1 and 320-2 of the intermediary service 320 ensure that for the application 160 to communicate with the core service 330, the applications 160 must adapt to the particular requirements and functions of the different core service 330. This specificity allows for efficient and effective communication tailored to the capabilities and constraints of each core service 330, ensuring robust and reliable data transmission across various DTN environments.

The message is sent through the core service 330 to a defined destination (a destination node or a destination service) identified by a Node ID or a Service ID (Endpoint ID according to the bundle protocol [RFC9171]), respectively, over another communication interface 370.

The core service 330 communicates with the DTN 130 using the bundle protocol, as specified in the IETF RFC9171, to transfer the message at the receiving end. At the receiving end, the asynchronous messaging system 101 is configured to transfer the message from the DTN 130 to the corresponding applications 160 (for instance, the applications 160-3, 160-4, 160-5). In an embodiment, one instance of the asynchronous messaging system 101-2 may facilitate the transfer message from the DTN 130 to the applications 160-3 and 160-4, whereas another instance of a synchronous messaging system 101-3 may facilitate the transfer message from the DTN 130 to the application 160-5.

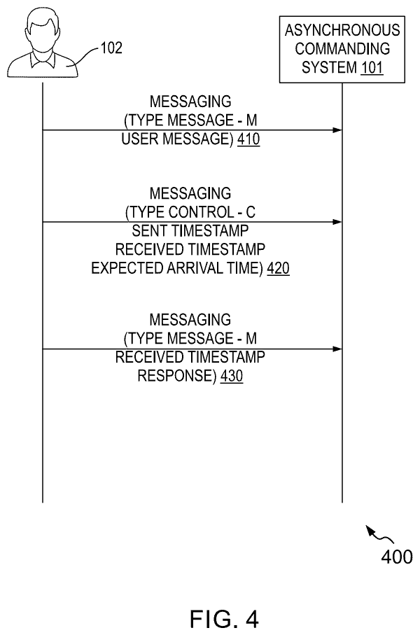

FIG. 4 illustrates a schematic 400 representing various types of messages communicated between the user 102 (through the application 160) and the asynchronous messaging system 101, in accordance with an embodiment of the present disclosure. The user 120 or the application 160 can send and receive data over the DTN 130 through the a synchronous messaging system 101. The interface service 310 supports users and applications with a synchronous message data and metadata. The messages and metadata can include:
Message 410 includes the user application message (e.g., an application command). (Type message-m)
Control messages 420 containing informational status and control instructions that include timestamps for message events (sent/received/failed), command messages, error messages, notification messages (Alerts, warnings, informational messages about system events), expected arrival times for messages sent by the user application (Type message-c), and
Message 430, which contains the remote response (if any) (Type message-m).

In an embodiment, each message, in addition to its contents, as described above, can include one or more of the following:
An authentication KEY, used to perform authentication of the message.
A UUID (Universal Unique Identifier), a 128-bit integer used to identify the message uniquely.
Message Type (Control, Message).
Endpoint identifier: Node identifier or Service identifier defined in RFC9171.
Endpoint scheme, e.g., IPN or DTN, as defined in RFC9171.

These values are generated and provided at different steps of the message lifetime and are all updated asynchronously. The asynchronous nature of the system ensures that messages are handled efficiently, without requiring immediate processing, which is critical for systems where operations may not occur in real-time or where there may be delays in communication. By utilizing these various message types, the system 101 ensures robust communication and efficient operation, catering to different needs and scenarios within the environment.

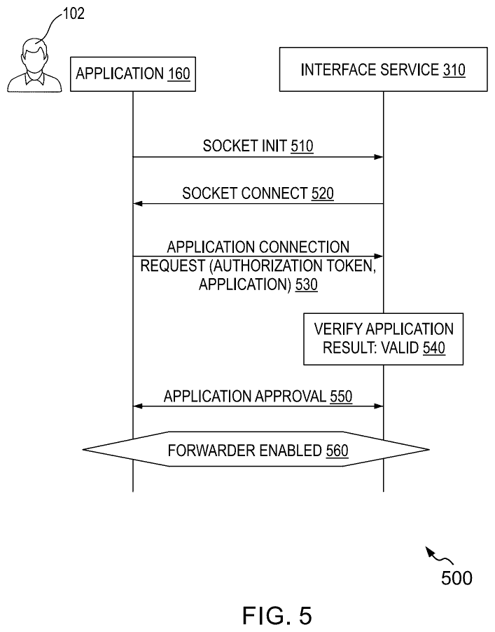

FIG. 5 illustrates a schematic representing communication between the application 160 and the interface service 310, in accordance with an embodiment of the present disclosure. Specifically, FIG. 5 depicts a process 500 for establishing a communication interface between the application 160 and the interface service 310. The process 500 for establishing the communication interface provides a layer of security to ensure only selected applications 160 can be connected to the interface service 310.

The process 500 starts with initialization of the system sockets, and upon initialization of the system sockets, the system sockets can validate the application 160 for connection. At step 510, the application 160 sends a request for socket initialization to the interface service 310. Upon receipt of the request, at step 520, the interface service 310 may send an indication that the socket to the application 160 has been established. The sockets are used to establish the initial connection. The sockets serve as the bridge between the application 160 and the interface service 310, enabling data exchange.

Once the sockets are initialized, the system 101 performs a validation process. In particular, at step 530, the application 160 may send an application connection request including an authorization token or an application identifier. The application 160 is associated with an application identifier. To increase security, a one-time authorization token is used alongside the application identifier on initialization. This token is generated by the application 160. The authorization token and the application identifier are included in the application connection request.

Upon receipt of the application connection request, at step 540, the interface service 310 may check the application 160 to ensure that the application 160 is authorized and capable of connecting with the interface service 310. In particular, the interface service 310 may validate the request based on the application identifier and the authorization token. The validation of the request is essential for security and compatibility, ensuring that only legitimate applications can establish a connection. Upon validation of the application 160, at step 550, the interface service 310 may send an approval indicating the validation of the application 160.

Upon the successful validation of the application 160, the interface service 310 initializes the service endpoint connector 320. The interface service 310 responds with application approval at step 550. In case validation is not successful, the validation is considered failed, and the socket is closed. Upon validation of the application 160 and transfer of application approval, at step 560, forwarding of application messages among the application 160, the interface service 310, and the service endpoint connector 320 is enabled.

While FIG. 5 illustrates socket connections for establishing communication between the application 160 and the interface service 310, the present disclosure is not limited to socket connections. For instance, the communication can be established between the application 160 and the interface service 310 through communication interfaces such as HTTP/HTTPS, WebSockets, RESTful APIs, or other standard or proprietary communication protocols.

As an alternative to the method 500, the process for establishing a communication interface between the application 160 and the interface service 310 can be performed by manually initializing all the nodes by an administrator. This manual initialization process involves the administrator providing the application identifiers as system arguments during the software initialization phase. Upon initialization, the administrator inputs specific application identifiers (application IDs) corresponding to each application requiring communication within the DTN 130. The application identifiers are passed as system arguments, facilitating the manual association between the applications and the respective nodes.

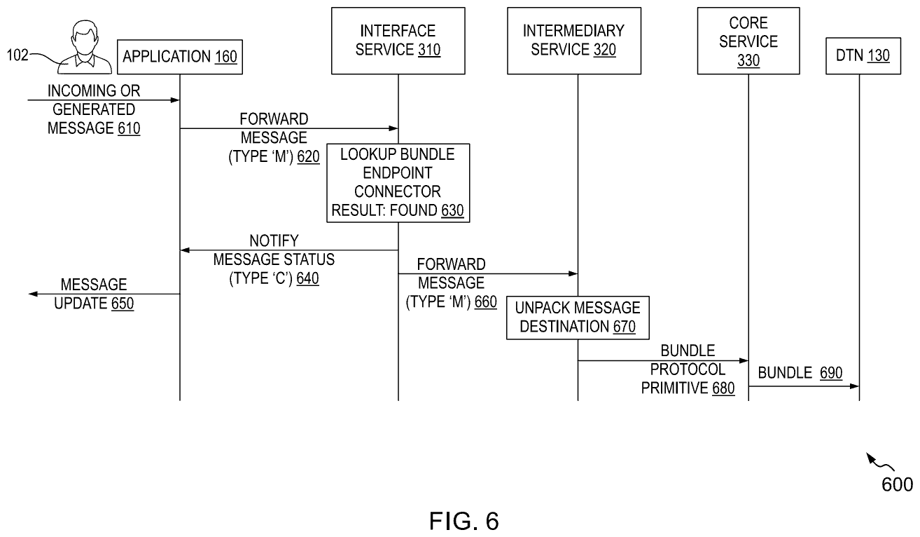

FIG. 6 illustrates a schematic representing a process 600 for transferring a message from the application 160 to the DTN 130, in accordance with an embodiment of the present disclosure. The process 600 for transferring the message initiates with the step 610. At step 610, the application 160 may generate the message to be transferred. In another embodiment, the application 160 may receive the message from a different application or an entity.

At step 620, the application 160 forwards/transfers the message to the interface service 310. The interface service 310 is the same interface that is initialized by the application 160 during the initialization process 500. The message can be of type-m message that may include an application command.

At step 630, the interface service 310 performs a lookup for a distinct instance 320-1 or 320-2 of the intermediary service 320, based on an Endpoint Identifier (EID) contained in the message. The EID may correspond to a destination node given by a Node ID or a destination service given by a Service ID. In an embodiment, upon receiving the message from the application 160, the interface service 310 may retrieve the EID. Then, the interface service 310 performs a lookup to identify the distinct instance 320-1 or 320-2 of the intermediary service 320 corresponding to the EID included in the message sent by the application 160. In several alternate embodiments, the distinct instance 320-1 or 320-2 of the intermediary service 320 is identified by performing a lookup for the distinct instance 320-1 or 320-2 based on the EID or the application identifier of the application 160 from which the message has been received.

At step 640, upon identification of the distinct instance 320-1 or 320-2 of the intermediary service 320, the interface service 310 sends a control message (type ‘c’) to the application 160 indicating that the message is successfully forwarded to the destination (message sent). The control message i.e., type ‘c’ message, may include informational status and control instructions that may include timestamps for message events and status of the message, such as sent, failed, etc. In case the message destination is not found in the lookup, this control message would indicate that the original message is not forwarded (message failed). Irrespective of whether the message destination is found or not, at step 650, upon receiving the control message, the application 160 may update the user or associated entity regarding the status of the message.

When the lookup is successful and the corresponding distinct instance 320-1 or 320-2 of the intermediary service 320 is identified, at step 660, the interface service 310 may forward the message (type ‘m’) to the identified distinct instance 320-1 or 320-2 of the intermediary service 320. The identified distinct instance 320-1 or 320-2 of the intermediary service 320 is responsible for handling messages in a specific way to ensure they can be processed by the core service 330.

At step 670, upon receipt of the message, the identified distinct instance 320-1 or 320-2 first extracts destination information from the message. The destination information indicates the information about the destination where the message is intended to go within the DTN 130. After extracting the destination information, the identified distinct instance 320-1 or 320-2 converts or transforms the message into a bundle that is compatible with the core service 330. This specific format is known as a bundle protocol primitive. The bundle protocol primitive includes a data packet that encapsulates the message and additional information (if any) needed for routing and delivery.

The bundle protocol primitive includes the information from the original application message, which indicates that the core data sent by the application 160 is part of the bundle protocol primitive, along with the necessary metadata for transmission. The bundle protocol primitives are the fundamental operations or data structures used by the core service 330 to handle messages. The bundle protocol primitives are tailored to the particular implementation of the core service 330 being used. For example, different implementations of the core service 330 might have slightly different ways of encoding and processing messages.

At step 680, the identified distinct instance 320-1 or 320-2 of the intermediary service 320 may transfer the message in the form of a bundle protocol primitive to the core service 330.

At step 690, the core service 330 sends an information bundle containing the information of the original application 160 to the destination identified by the endpoint ID, through the DTN 130. This endpoint ID uniquely identifies the target endpoint within the DTN 130 to ensure that the message reaches the correct recipient.

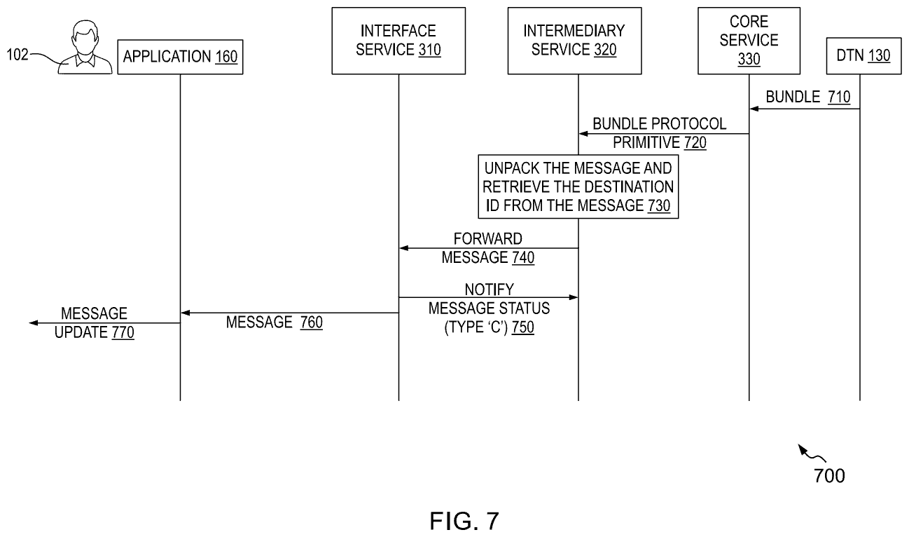

FIG. 7 illustrates a schematic representing a process 700 for transferring a message from the DTN 130 to the application 160, in accordance with embodiments of the present disclosure.

The process 700 for transferring a message from the DTN 130 to the application 160 initiates with step 710. At step 710, the bundle from the DTN 130 is forwarded to the core service 330 of the instance of the system 101 at the destination.

Upon receipt of the bundle from the DTN 130, the core service 330 may retrieve the EID from the information bundle and convert the information bundle into the bundle protocol primitive specific to the core service 330. The bundle protocol primitive format is specific to each core service 330 implementation. At step 720, the core service 330 transfers the bundle protocol primitive to a distinct instance 320-1 or 320-2 of the intermediary service 320. The distinct instance 320-1 or 320-2 for receiving the bundle protocol primitive is identified based on the EID.

At step 730, the identified distinct instance 320-1 or 320-2 of the intermediary service 320, upon reception of the bundle in the form of the bundle protocol primitive, unpacks the message and retrieves the EID.

At step 740, the identified distinct instance 320-1 or 320-2 of the intermediary service 320 sends the message (message type ‘m’) to the interface service 310 based on the mapping between applications 160 and instances 320-1 or 320-2 of the intermediary service 320, maintained by the interface service 310.

At step 750, the interface service 310 sends a control message (type ‘c’) to the identified distinct instance 320-1 or 320-2 of the intermediary service 320, indicating the message is successfully forwarded to the destination (message delivered). At step 760, the interface service 310 may forward/send the message to the application 160, where the application 160 is the same application that is identified with the application identifier exchanged during the application initialization process 500. At step 770, the application 160 may notify the user regarding the status of the message.

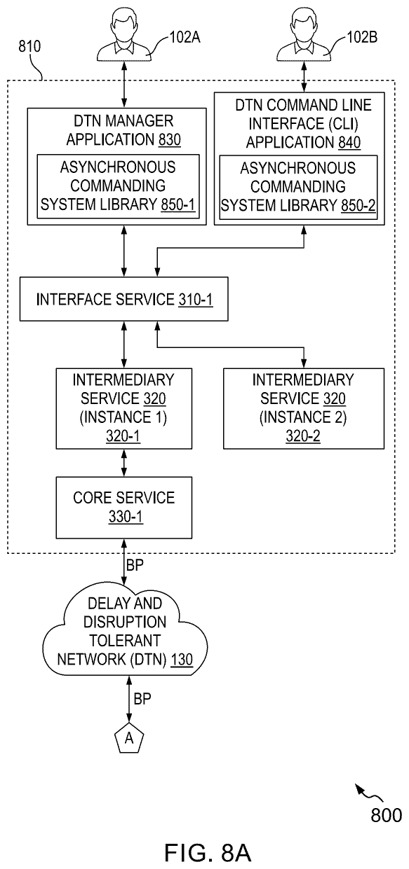

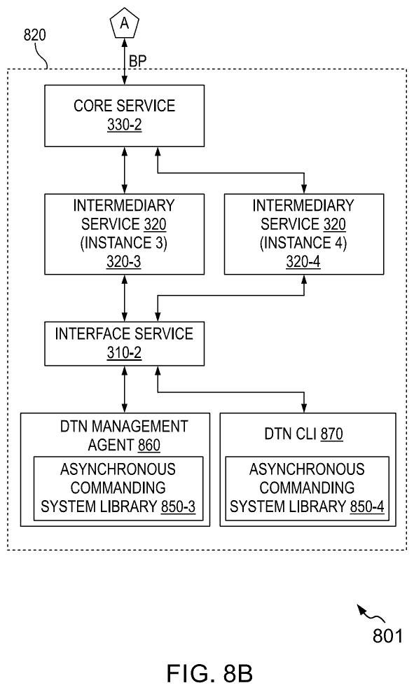

FIGS. 8A-8B illustrates chematics representing an end-to-end process for transferring a message between applications through the DTN 130 via the asynchronous messaging system 101 when two applications transfer messages to the DTN 130, in accordance with embodiments of the present disclosure. As illustrated in FIGS. 8A and 8B, the representations 800 and 801 show two applications, viz., a DTN manager application 830 and a DTN Command Line Interface (CLI) application 840 that can transfer the messages through the DTN 130. The applications 830 and 840 are similar to application 160 as explained above.

FIGS. 8A and 8B show how two specific applications, the DTN manager application 830 and the DTN CLI application 840, interact with the DTN 130. The applications 830 and 840 serve different functions, but both applications can send and receive messages through the DTN manager application suite 810 and a managed DTN node 820. The DTN manager application 830 can handle the overall management and monitoring of the DTN 130, while the DTN CLI application 840 provides a command-line interface for users to interact with the DTN 130.

The DTN manager application 830 can perform node and network management functions of the DTN 130. The DTN manager application 830, which may reside in a DTN manager application suite 810 (interchangeably referred to as DTN manager 810), incorporating the applications 160 and asynchronous messaging system 101, integrates an asynchronous messaging system library 850-1 to connect the application 160 to the elements of the asynchronous messaging system 101. The DTN manager application suite 810 can house various tools and components, such as an instance 310-1 of the interface service 310, two distinct instances 320-1 and 320-2 of the intermediary service 320, an instance 330-1 of the core service 330, etc. necessary for effective DTN management. Similarly, the managed DTN node 820 can house various tools and components such as another instance 310-2 of the interface service 310, two further distinct instances 320-3 and 320-4 of the intermediary service 320, and another instance 330-2 of the core service 330, etc. necessary for effective DTN management.

The DTN Manager application 830 enables the administrative user (also referred to as “administrator”) to perform management functions and administrative operations on the managed DTN node 820, through the DTN management agent 860, which incorporates an asynchronous messaging system library 850-3. The DTN management agent 860 can therefore receive commands (interchangeably referred to as “controls”) from the DTN Manager application 830 and issue responses to the DTN Manager application 830. The commands may include node bootstrapping, node configuration, and contact plan updates, among others. The DTN CLI application 840 may facilitate communication and control within the DTN 130. The DTN CLI application 840 may operate through a command line interface, making the DTN CLI application 840 accessible for users who prefer or require command line interactions. The application 840 may allow a user to send and receive asynchronous commands and responses through a command line interface over the DTN 130.

In an embodiment, the DTN CLI application 840 can integrate an asynchronous messaging system library 850-2 to connect the application 840 to the various elements of the asynchronous messaging system 101. The DTN CLI application 840 may be collocated within the DTN manager 810, the managed DTN node 820, or may be standalone. The DTN CLI application 840 can issue commands and receive appropriate responses over the DTN 130 to any authorized DTN CLI application 870 that incorporates an asynchronous messaging system library 850-4. The commands may include sending data of multiple types, such as text, files, streaming, requesting node/application information, including version, node state, node configuration, accessing operating system commands, and others. In the DTN CLI application 870, each command is assigned a unique Universally Unique Identifier (UUID). This unique identifier ensures that all communications are traceable and managed asynchronously, preventing any process from waiting for a response from the resource the process has called. In this manner, all communications work asynchronously, i.e., each process sends commands or messages without pausing to wait for a response. This means that when a command is issued, the system does not halt operations to wait for the response to that command.

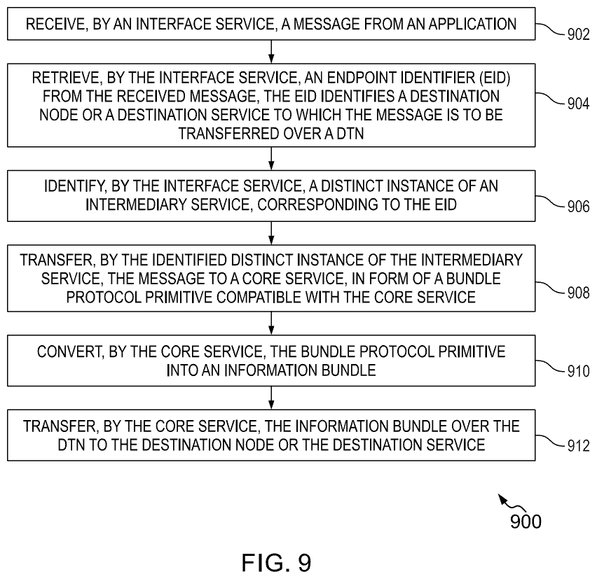

FIG. 9 illustrates a computer-implemented method 900 for transferring an asynchronous message over the DTN 130, through the asynchronous messaging system 101, in accordance with an embodiment of the present disclosure. The various steps and/or operations of the computer-implemented method 900, and combinations of steps/operations in the flow diagram, may be implemented by, for example, hardware, firmware, a processor, circuitry, and/or a system such as the asynchronous messaging system 101 explained with reference to FIG. 1 and/or by a different device associated with the execution of software that includes one or more computer program instructions. The computer-implemented method 900 begins at Step 902.

At Step 902, the interface service 310 receives a message from the application 160 (for example, the message may be received from one of the applications 160-1, 160-2, 160-3, 160-4, or 160-5). In one embodiment, the interface service 310 receives a request for socket initialization from the application 160. Furthermore, the interface service 310 initializes a socket for data exchange and validates the application through an authorization token or an application identifier included in the request for socket initialization. Furthermore, in several embodiments, the message includes an authentication key for authentication of the message, a universal unique identifier for identification of the message, an Endpoint Identifier (EID) including a node identifier or a service identifier, and an endpoint scheme. Furthermore, the message may be selected from a group consisting of user application messages and control messages.

At Step 904, the interface service 310 retrieves the EID from the received message, the EID identifies a destination node or a destination service to which the message is to be transferred over the DTN 130.

At Step 906, the interface service 310 identifies a distinct instance 320-1 or 320-2 of the intermediary service 320 corresponding to the EID. In several embodiments, the interface service 310 maintains a mapping between the one or more distinct instances 320-1 and 320-2 of the intermediary service 320 and one or more respective applications 160. Furthermore, in several embodiments, the distinct instance 320-1 or 320-2 of the intermediary service 320 is identified by performing a lookup for the distinct instance 320-1 or 320-2 based on the EID or an application identifier of the application from which the message has been received.

At Step 908, the identified distinct instance 320-1 or 320-2 of the intermediary service 320 transfers the message to the core service 330, in form of a bundle protocol primitive compatible with the core service 330. In one embodiment, the interface service 310 maintains a mapping between the application 160 and a core service endpoint 329-1 or 329-2 of the core service 330.

At Step 910, the core service 330 converts the bundle protocol primitive into an information bundle.

At Step 912, the core service 330 transfers the information bundle over the DTN 130 to the destination node or the destination service. The interface service 310, the one or more distinct instances 320-1 or 320-2 of the intermediary service 320, and the core service 330 are configured to operate in accordance with the Bundle Protocol.

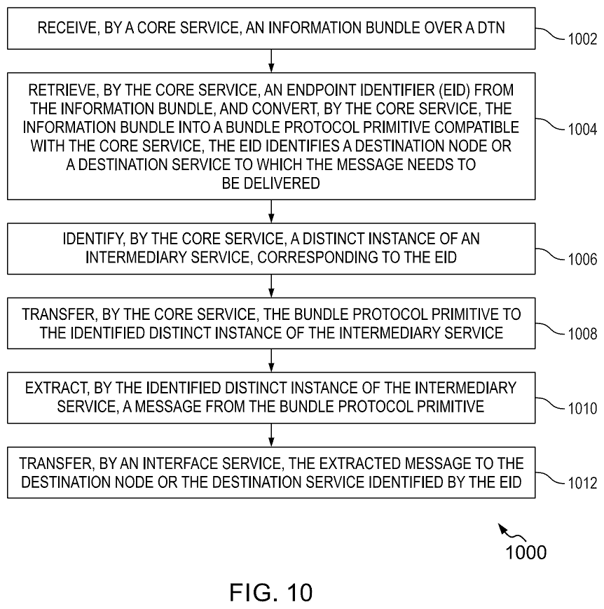

FIG. 10 illustrates a computer-implemented method 1000 for receiving an asynchronous message over the DTN 130, through the asynchronous messaging system 101, in accordance with an embodiment of the present disclosure. The various steps and/or operations of the computer-implemented method 1000, and combinations of steps/operations in the flow diagram, may be implemented by, for example, hardware, firmware, a processor, circuitry, and/or a system such as the asynchronous messaging system 101 explained with reference to FIG. 1 and/or by a different device associated with the execution of software that includes one or more computer program instructions. The computer-implemented method 1000 begins at Step 1002.

At Step 1002, the core service 330 receives an information bundle over the DTN 130.

At Step 1004, the core service 330 retrieves an EID from the information bundle and converts the information bundle into a bundle protocol primitive compatible with the core service 330.

At Step 1006, the core service 330 identifies a distinct instance 320-1 or 320-2 of the intermediary service 320 by performing a lookup for the distinct instance 320-1 or 320-2 based on the EID.

At Step 1008, the core service 330 transfers the bundle protocol primitive to the identified distinct instance 320-1 or 320-2 of the intermediary service 320.

At Step 1010, the identified distinct instance 320-1 or 320-2 of the intermediary service 320 extracts a message from the bundle protocol primitive.

At Step 1012, the interface service 310 transfers the extracted message to a destination node or a destination service identified by the EID. Here again, the interface service 310, the one or more distinct instances 320-1 or 320-2 of the intermediary service 320, and the core service 330 are configured to operate in accordance with the Bundle Protocol.

The disclosed asynchronous messaging system and computer-implemented method offer several advantages, particularly in the context of Delay Tolerant Networks (DTNs). One significant benefit is its inherent resilience to network volatility. Unlike conventional services that require stable, real-time sessions and fail if connections break, the embodiments are designed to function correctly even when completely isolated for extended periods, processing data only when bundles finally arrive. This makes it highly suitable for environments with intermittent connectivity and significant delays.

Furthermore, the clear distribution of responsibilities among the interface service, distinct instances of the intermediary service, and the core service offers significant architectural and operational advantages within the DTN. The modularity allows for specialized development and optimization of each component. The interface service, for instance, focuses solely on establishing secure connections with applications and acting as a message broker. The interface service handles initial socket initialization, application validation through authorization tokens, and maintains a mapping between applications and intermediary service instances. This separation means the interface service does not need to be aware of the specific details or implementations of the underlying core service, making it highly adaptable to various DTN configurations.

Distinct instances of the intermediary service are responsible for tailoring messages to specific core service implementations and applications. Each instance is built for a unique configuration of the core service and acts as a forwarder and receiver of messages, transforming them into a format specific to the core service (e.g., a byte-stream). This localized responsibility for data transformation and mapping between application communication interfaces and core service primitives ensures seamless interaction despite differences in underlying network protocols. It allows for accommodating various forwarding functions and requirements unique to each type of core service, promoting flexibility and scalability.

Furthermore, the core service focuses on the fundamental aspects of Bundle Protocol (BP) implementation and data transmission within the DTN. The responsibilities of the core service include memory management, message reception and delivery according to BP specifications, interfacing with various transport protocols (TCP, LTP, UDP), and implementing comprehensive security measures. By offloading application-specific interactions and message transformations to the interface and intermediary services, the core service can remain optimized for reliable and efficient data communication in highly challenging network environments. This clear separation of concerns enhances maintainability, simplifies debugging, and allows for independent upgrades or modifications to each layer without impacting the others, ultimately leading to a more robust and adaptable DTN system.

Another advantage lies in its secure and efficient data handling. The core service implements comprehensive security measures, including encryption, authentication, and integrity checks, to protect the confidentiality and integrity of bundles during transmission. Additionally, data handling within the core service utilizes a combination of process memory for quick access and persistent logs for data recovery and auditing, ensuring critical information about bundle transactions is retained across system reboots or failures. The asynchronous nature of the system also ensures efficient message handling without requiring immediate processing, which is crucial for systems where real-time operations or continuous connectivity are not always possible.

The disclosed method with reference to FIGS. 3-10, or one or more operations of the system 101 or 200 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, netbook, Web book, tablet computing device, smartphone, or other mobile computing devices).

Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the asynchronous messaging system and its various components may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or the computer to perform one or more operations. A computer-readable medium storing, embodying, or encoding a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media.

Examples of non-transitory computer-readable media include magnetic storage media (such as floppy disks, magnetic tapes, hard disk drives, etc.), optical magnetic storage media (e.g. magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different from those that are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for transferring an asynchronous message over a Delay and Disruption Tolerant Network (DTN), through an asynchronous messaging system configured to run at least an interface service, one or more distinct instances of an intermediary service, and a core service, the computer-implemented method comprising:
receiving, by the interface service, a message from an application;
retrieving, by the interface service, an Endpoint Identifier (EID) from the received message, wherein the EID identifies a destination node or a destination service to which the message is to be transferred over the DTN;
identifying, by the interface service, a distinct instance of the intermediary service, corresponding to the EID;
transferring, by the identified distinct instance of the intermediary service, the message to the core service, in form of a bundle protocol primitive compatible with the core service;
converting, by the core service, the bundle protocol primitive into an information bundle, and
transferring, by the core service, the information bundle over the DTN to the destination node or the destination service,
wherein the interface service, the one or more distinct instances of the intermediary service, and the core service are configured to operate in accordance with Bundle Protocol (BP).

2. The computer-implemented method as claimed in claim 1, further comprising:
receiving, by the interface service, a request for socket initialization from the application; and
initializing, by the interface service, a socket for data exchange, and validating, by the interface service, the application through an authorization token or an application identifier included in the request for socket initialization.

3. The computer-implemented method as claimed in claim 1, wherein the interface service maintains a mapping between the one or more distinct instances of the intermediary service and one or more respective applications.

4. The computer-implemented method as claimed in claim 3, wherein the instance of the intermediary service is identified by performing a lookup for the instance based on the EID or an application identifier of the application from which the message has been received.

5. The computer-implemented method as claimed in claim 1, wherein the interface service maintains a mapping between the application and a core service endpoint of the core service.

6. The computer-implemented method as claimed in claim 1, wherein the application is one or more of a DTN manager application or a DTN Command Line Interface (CLI) application, the DTN manager application and DTN CLI application configured to enable performance of administrative operations on a managed DTN node.

7. The computer-implemented method as claimed in claim 6, wherein the DTN manager application and the DTN CLI application are configured to issue commands and receive responses, to and from the managed DTN node, respectively, by integrating an asynchronous messaging system library.

8. The computer-implemented method as claimed in claim 1, wherein the message is one or more of a user application message or a control message.

9. The computer-implemented method as claimed in claim 1, wherein the message comprises an authentication key for authentication of the message, a universal unique identifier for identification of the message, the EID comprising a node identifier or a service identifier, and an endpoint scheme.

10. A computer-implemented method for receiving an asynchronous message over a Delay and Disruption Tolerant Network (DTN), through an asynchronous messaging system configured to run at least an interface service, one or more distinct instances of an intermediary service, and a core service, the computer-implemented method comprising:
receiving, by the core service, an information bundle over the DTN;
retrieving, by the core service, an Endpoint Identifier (EID) from the information bundle, and converting, by the core service, the information bundle into a bundle protocol primitive compatible with the core service, wherein the EID identifies a destination node or a destination service to which the message needs to be delivered;
identifying, by the core service, a distinct instance of the intermediary service, corresponding to the EID;
transferring, by the core service, the bundle protocol primitive to the identified distinct instance of the intermediary service;
extracting, by the identified distinct instance of the intermediary service, a message from the bundle protocol primitive; and
transferring, by the interface service, the extracted message to the destination node or the destination service identified by the EID,
wherein the interface service, the one or more distinct instances of the intermediary service, and the core service are configured to operate in accordance with Bundle Protocol (BP).

11. An asynchronous messaging system for transferring an asynchronous message over a Delay and Disruption Tolerant Network (DTN), the asynchronous messaging system comprising:
a memory unit comprising machine-readable instructions; and
a processor operably connected to the memory unit, the processor configured to execute the machine-readable instructions, that when executed by the processor, enable the asynchronous messaging system to run at least an interface service, one or more distinct instances of an intermediary service, and a core service, wherein:
the interface service is configured to:
receiving a message from an application,
retrieve an Endpoint Identifier (EID) from the received message, wherein the EID identifies a destination node or a destination service to which the message is to be transferred over the DTN, and
identify a distinct instance of the intermediary service, corresponding to the EID,
the identified distinct instance of the intermediary service is configured to:
transfer the message to the core service, in form of a bundle protocol primitive compatible with the core service, and
the core service is configured to:
convert the bundle protocol primitive into an information bundle, and
transfer the information bundle over the DTN to the destination node or the destination service,
wherein the interface service, the one or more distinct instances of the intermediary service, and the core service are configured to operate in accordance with Bundle Protocol (BP).

12. The asynchronous messaging system as claimed in claim 11, wherein the interface service is further configured to:
receive a request for socket initialization from the application; and
initialize a socket for data exchange, and validate the application through an authorization token or an application identifier included in the request for socket initialization.

13. The asynchronous messaging system as claimed in claim 11, wherein the interface service is further configured to maintain a mapping between the one or more distinct instances of the intermediary service and one or more respective applications.

14. The asynchronous messaging system as claimed in claim 13, wherein the interface service is configured to identify the instance of the intermediary service by performing a lookup for the instance based on the EID or an application identifier of the application from which the message has been received.

15. The asynchronous messaging system as claimed in claim 11, wherein the interface service is further configured to maintain a mapping between the application and a core service endpoint of the core service.

16. The asynchronous messaging system as claimed in claim 11, wherein the application is one or more of a DTN manager application or a DTN Command Line Interface (CLI) application, the DTN manager application and DTN CLI application configured to enable performance of administrative operations on a managed DTN node.

17. The asynchronous messaging system as claimed in claim 16, wherein the DTN manager application and the DTN CLI application are configured to issue commands and receive responses, to and from the managed DTN node, respectively, by integrating an asynchronous messaging system library.

18. The asynchronous messaging system as claimed in claim 11, wherein the message is one or more of a user application message or a control message.

19. The asynchronous messaging system as claimed in claim 11, wherein the message comprises an authentication key for authentication of the message, a universal unique identifier for identification of the message, the EID comprising a node identifier or a service identifier, and an endpoint scheme.

20. An asynchronous messaging system for receiving an asynchronous message over a Delay and Disruption Tolerant Network (DTN), the asynchronous messaging system comprising:
a memory unit comprising machine-readable instructions; and
a processor operably connected to the memory unit, the processor configured to execute the machine-readable instructions, that when executed by the processor, enable the asynchronous messaging system to run at least an interface service, one or more distinct instances of an intermediary service, and a core service, wherein:
the core service is configured to:
receive an information bundle over the DTN,
retrieve an Endpoint Identifier (EID) from the information bundle, and convert the information bundle into a bundle protocol primitive compatible with the core service, wherein the EID identifies a destination node or a destination service to which the message needs to be delivered,
identify a distinct instance of the intermediary service, corresponding to the EID, and
transfer the bundle protocol primitive to the identified distinct instance of the intermediary service,
the identified distinct instance of the intermediary service is configured to:
extract a message from the bundle protocol primitive, and
the interface service is configured to:
transfer the extracted message to the destination node or the destination service identified by the EID,
wherein the interface service, the one or more distinct instances of the intermediary service, and the core service are configured to operate in accordance with Bundle Protocol (BP).
